(19) United States
(12) Patent Application Publication
(10) Pub. No.: US 2022/0393185 A1
(43) Pub. Date: Dec. 8, 2022

(54) ELECTRICAL CONTACT MATERIAL FOR INTEGRATION AS A CONTACT LAYER IN A REVERSIBLE SOLID-OXIDE FUEL CELL

(71) Applicant: SeeO2 Energy Inc., Calgary (CA)

(72) Inventors: Paul Addo, Calgary (CA); Beatriz Molero Sanchez, Calgary (CA); Kalpana Singh, Calgary (CA); Santiago Jimenez-Villegas, Calgary (CA); Haris Ansari, Calgary (CA)

(21) Appl. No.: 17/828,996

(22) Filed: May 31, 2022

Related U.S. Application Data
(60) Provisional application No. 63/194,720, filed on May 28, 2021.

(51) Int. Cl. H01M 4/90; H01M 4/88; H01M 8/1213

(52) U.S. Cl. CPC H01M 4/9033; H01M 4/8885; H01M 8/1213; H01M 2008/1293

(57) ABSTRACT

One variation of a contact material includes: a base material including a first amount of Lanthanum, a second amount of Nickel, and a third amount of Oxygen; a fourth amount of a first doping agent configured to stabilize a crystal structure of the base material; and a fifth amount of a second doping agent, in the set of doping agents, configured to limit thermal expansion of the base material. The contact material exhibits: a thermal expansion coefficient between 10.0×10⁻⁶K⁻¹ and 15.0×10⁻⁶K⁻¹ at temperatures between 25 degrees Celsius and 1100 degrees Celsius; and an electrical conductivity greater than 200 Siemens-per-centimeter at temperatures within a temperature range of 700 degrees Celsius to 1300 degrees Celsius.

### CROSS-REFERENCE TO RELATED APPLICATIONS

This Application claims the benefit of U.S. Provisional Application No. 63/194,720, filed on 28 May 2021, which is incorporated in its entirety by this reference.

### TECHNICAL FIELD

This invention relates generally to the field of reversible solid-oxide fuel cells and more specifically to a new and useful composition for a contact material in the field of reversible solid-oxide fuel cells.

### BRIEF DESCRIPTION OF THE FIGURES

FIG. 1 is a schematic representation of a fuel cell stack;

FIG. 2 is a graphical representation of a contact material;

FIG. 3 is a graphical representation of a contact material;

FIG. 4 is a graphical representation of a contact material;

FIG. 5 is a graphical representation of a contact material;

FIG. 6 is a graphical representation of a contact material;

FIG. 7 is a graphical representation of a contact material;

FIG. 8 is a graphical representation of a contact material;

FIGS. 9A-9C are graphical representations of a contact material;

FIGS. 10A-10C are graphical representations of a contact material;

FIG. 11 is a graphical representation of a contact material;

FIG. 12 is a graphical representation of a contact material;

FIG. 13 is a graphical representation of a contact material;

FIGS. 14A and 14B are schematic representations of a reversible solid oxide fuel cell; and

FIGS. 15A-15F are schematic representations of a fuel cell stack.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Contact Material

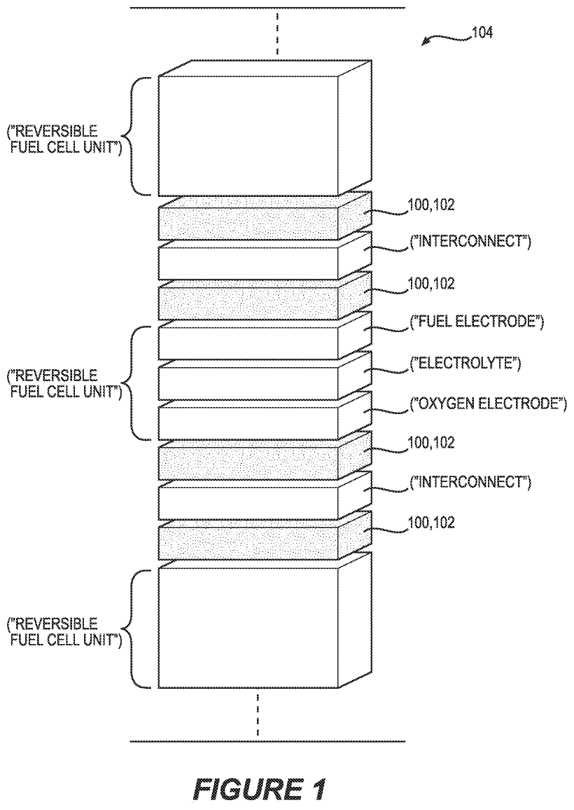

As shown in FIGS. 1-15F, a contact material 100 includes: a base material including a first amount of Lanthanum (or “La”), a second amount of Nickel (or “Ni”), and a third amount of Oxygen (or “O”); a fourth amount of a first doping agent configured to stabilize a crystal structure of the base material; and a fifth amount of a second doping agent, in the set of doping agents, configured to limit thermal expansion of the base material. The contact material 100 exhibits: a thermal expansion coefficient between 10.0×10⁻⁶K⁻¹ and 15.0×10⁻⁶K⁻¹ at temperatures between 25 degrees Celsius and 1100 degrees Celsius; and an electrical conductivity greater than 200 Siemens-per-centimeter at temperatures within a temperature range of 700 degrees Celsius to 1300 degrees Celsius.

One variation of the contact material 100 includes: a base material including a first amount of Lanthanum, a second amount of Nickel, and a fourth amount of Oxygen; a third amount of Iron (or “Fe”) configured to stabilize the base material; and a fifth amount of a doping agent configured to limit thermal expansion of the base material. The contact material 100 exhibits: a thermal expansion coefficient between 10.0×10⁻⁶K⁻¹ and 15.0×10⁻⁶K⁻¹ at temperatures between 25 degrees Celsius and 1100 degrees Celsius; and an electrical conductivity greater than 200 Siemens-per-centimeter at temperatures within a temperature range of 700 degrees Celsius to 1300 degrees Celsius.

One variation of the contact material 100 includes: a base material including a first amount of Lanthanum, a second amount of Nickel, a fourth amount of Oxygen; a third amount of Cobalt (or “Co”) configured to stabilize the base material; and a fifth amount of a doping agent configured to limit thermal expansion of the base material. The contact material 100 exhibits: electrical conductivity values greater than 300 Siemens-per-centimeter at temperatures within a temperature range of 700 degrees Celsius to 1300 degrees Celsius; and a target thermal expansion coefficient within a threshold deviation of a first thermal expansion coefficient of an electrode material and a second thermal expansion coefficient of an interconnect material.

One variation of the contact material 100 includes LaNi_{0.6}Fe_{0.4-x}MₓO_{3-δ}. In this contact material 100: M=Cr, Cu; and x=0, 0.1, 0.2, 0.3, 0.4.

One variation of the contact material 100 includes LaNi_{0.6}Fe_{0.3}Cu_{0.1}O_{3-δ}.

One variation of the contact material 100 includes LaNi_{0.6}Fe_{0.2}Cu_{0.2}O_{3-δ}.

One variation of the contact material 100 includes LaNiₓCo_{y}M_{z}O_{3-δ}. In this contact material 100: M=Fe, Cr, Cu; x=0.3, 0.5, 0.6; y=0.1, 0.2, 0.3, 0.4; z=0, 0.1, 0.2, 0.3.

One variation of the contact material 100 includes LaNi_{0.6}Co_{0.4-x}MₓO_{3-δ}. In this contact material 100: M=Fe, Cr, Cu; and x=0, 0.1, 0.2, 0.3.

One variation of the contact material 100 includes LaNi_{0.6}Co_{0.4-x}FeₓO_{3-δ}.

One variation of the contact material 100 includes LaNi_{0.6}Co_{0.2}Fe_{0.2}O_{3-δ}.

One variation of the contact material 100 includes LaNi_{0.6}Co_{0.3}Fe_{0.1}O_{3-δ}.

One variation of the contact material 100 includes LaNi_{0.6}Co_{0.1}Cr_{0.3}O₃.

One variation of the contact material 100 includes LaNi_{0.5}Co_{0.2}Cu_{0.3}O_{3-δ}.

One variation of the contact material 100 includes LaNi_{0.3}Co_{0.4}Cu_{0.3}O_{3-δ}.

One variation of the contact material 100 includes: La_{0.3}Ca_{0.6}Ce_{0.1}Fe_{0.6}Ni_{0.1}Cr_{0.3}O_{3-δ}.

### 2. Reversible Fuel Cell Stack

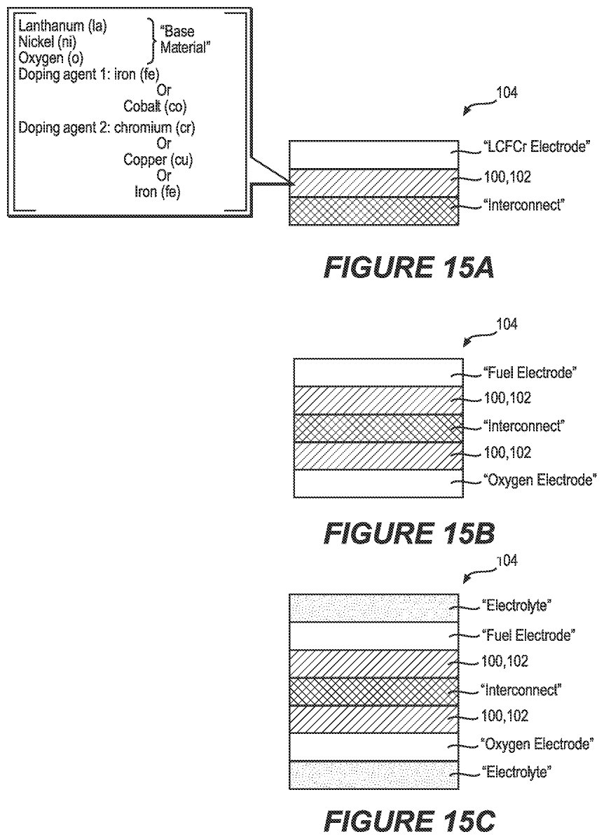

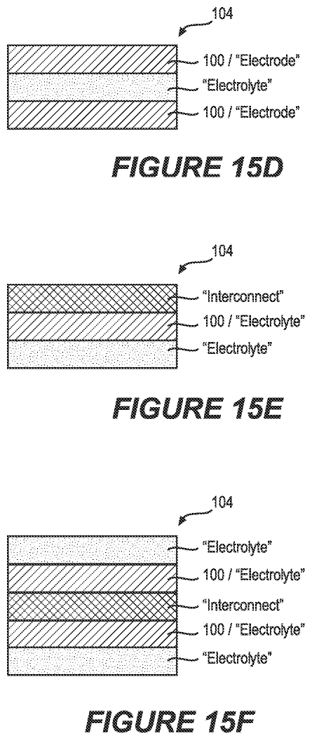

As shown in FIGS. 1 and 15A-15C, a reversible fuel cell unit includes: an oxygen electrode (e.g., anode) arranged across a first surface of an electrolyte material; and a fuel electrode (e.g., cathode) arranged across a second surface of the electrolyte material opposite the first surface.

A reversible fuel cell stack 104 (or “stack” 104) (e.g., a reversible solid-oxide fuel cell stack) includes: a first fuel cell; a second fuel cell; an interconnect; and a set of contact layers 102. The first fuel cell includes: a first electrolyte; a first oxygen electrode, in a set of oxygen electrodes, arranged across a first surface of the first electrolyte; and a first fuel electrode, in a set of fuel electrodes, arranged across a second surface, opposite the first surface, of the first electrolyte. The second fuel cell includes: a second fuel cell comprising: a second electrolyte; a second oxygen electrode, in the set of oxygen electrodes, arranged across a third surface of the second electrolyte; and a second fuel electrode, in the set of fuel electrodes, arranged across a fourth surface, opposite the third surface, of the second electrolyte. The interconnect is arranged between the second surface of the first fuel cell and the third surface of the second fuel cell. The set of contact layers 102 includes: a first contact layer 102, arranged between the interconnect and the second surface of the first fuel cell unit, configured to electrically couple the interconnect to the first fuel electrode; and a second contact layer 102, arranged between the interconnect and the third surface of the second fuel cell unit, configured to electrically couple the interconnect to the second oxygen electrode.

In one variation, the reversible fuel cell stack 104 includes: a first reversible fuel cell unit; a second reversible fuel cell unit; an interconnect arranged between the first reversible fuel cell unit and the second reversible fuel cell unit; a first contact layer 102, formed of the contact material 100, arranged between the interconnect and the first reversible fuel cell unit; and a second contact layer 102, formed of the contact material 100, arranged between the interconnect and the second reversible fuel cell unit.

In one variation, the reversible fuel cell stack 104 includes: a set of reversible fuel cell units; a set of interconnects, each interconnect, in the set of interconnects, arranged between each reversible fuel cell unit, in the set of reversible fuel cell units; and a set of contact layers 102 formed of the contact material 100, each contact layer 102, in the set of contact layers 102, arranged between each interconnect, in the set of interconnects, and each reversible fuel cell unit, in the set of reversible fuel cell units.

In one variation, as shown in FIGS. 15D-15F, the reversible fuel cell stack 104 includes: an electrolyte; a first electrode (e.g., an oxygen electrode) formed of the contact material 100 and applied to a first surface of the electrolyte; and a second electrode (e.g., a fuel electrode) formed of the contact material 100 and applied to a second surface, opposite the first surface, of the electrolyte. In this variation, the reversible fuel cell stack 104 can further include: a second electrolyte; a third electrode formed of the contact material 100 and applied to a surface of the second electrolyte; and an interconnect arranged between and contacting the second electrode and third electrode.

### 3. Applications

Generally, a contact material 100 is configured to form a contact layer 102 between an interconnect and an electrode in a solid oxide fuel cell (or “SOFC”) stack, a solid oxide electrolysis cell (SOEC) and/or a reversible solid oxide fuel cell (or “RSOFC) stack.

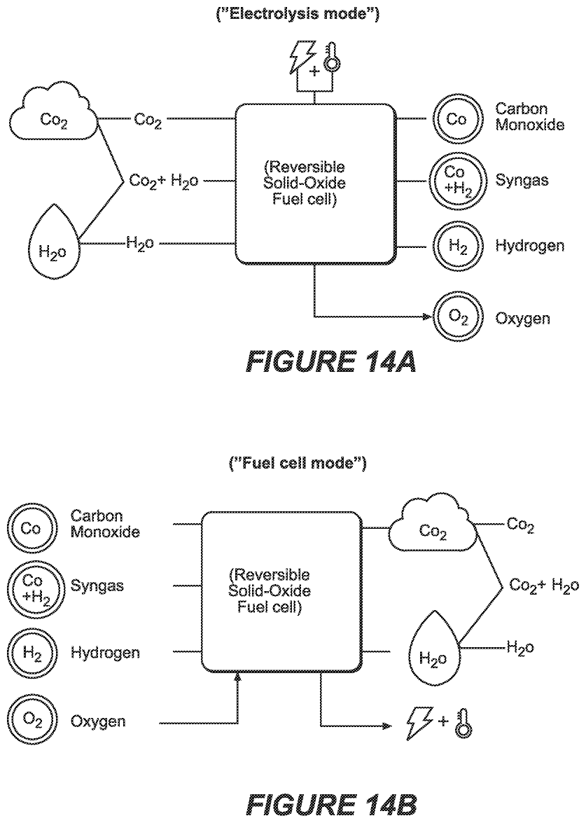

In particular, as shown in FIGS. 14A and 14B, an RSOFC can operate in both a fuel cell mode (i.e., SOFC mode), in which chemical energy (e.g., hydrogen, natural gas, hydrocarbons, syngas, carbon monoxide) is converted to electrical energy, and in an electrolysis mode (i.e., SOEC mode), in which electrical energy is converted back to chemical energy (e.g., syngas, carbon monoxide, hydrogen, oxygen) via electrolysis of water and/or carbon dioxide.

As shown in FIG. 1, a single RSOFC cell unit can include: an electrolyte material (e.g., ScSZ electrolyte material); a fuel electrode (i.e., anode in the SOFC mode or cathode in the SOEC mode), arranged across a first surface of the electrolyte material, and an oxygen electrode (i.e., cathode in the SOFC mode or anode in the SOEC mode), arranged across a second surface of the electrolyte material opposite the first surface.

These individual RSOFC cell units can be arranged to form a stack (e.g., an RSOFC stack), including an interconnect (e.g., Crofer 22 APU) arranged between each individual RSOFC cell unit in the stack 104. Each interconnect thereby functions as a connector between an oxygen electrode of a first cell unit, in the stack 104, and a fuel electrode of a second cell unit, in the stack 104. Therefore, to improve efficiency (e.g., electrochemical efficiency) of the stack 104, the electrodes or interconnect can be coated with a contact material 100 that enables materials (e.g., electrode and interconnect materials) of the stack 104 to tolerate both conversion of electrical energy to chemical energy (e.g., in electrolysis mode) and vice versa (e.g., in fuel cell mode).

The contact material 100 can therefore form a contact layer 102 arranged between each interconnect and each electrode in the stack 104 to enable compatibility (e.g., chemical, electrochemical, thermal expansion, reactivity) between: the interconnect and the fuel electrode; and the interconnect and the oxygen electrode. In particular, the contact material 100 can be configured to: bond and electrically connect the interconnect to the oxygen electrode of the fuel cell unit; minimize delamination, deformation, and/or cell fracture issues during thermal cycling due to differences in thermal expansion properties of the contact material 100, interconnect, and electrode materials; and enable stable electrochemical performance of the stack 104 (e.g., by minimizing interfacial ohmic resistance between the contact material 100, interconnect, and electrode materials) over many cycles.

Thus, the contact material 100 can be configured to exhibit: high electrical conductivity (e.g., greater than 250 S/cm) at relatively high operating temperatures (e.g., between 700 degrees Celsius and 1300 degrees Celsius) and thereby exhibit relatively low interfacial resistance between the electrodes and the interconnect; thermal expansion coefficients matched (e.g., within a threshold deviation of ten percent) to thermal expansion coefficients (hereinafter “TEC values”) of the interconnect and electrode materials; minimal reactivity with the interconnect and electrode materials; and sintering behavior matched (e.g., within a threshold deviation of twenty percent) to the interconnect and electrode materials, thereby enabling strong adhesion of the contact material 100 with the interconnect and electrode materials.

Therefore, the contact material 100 enables long-term electrochemical performance of the stack 104 in both the fuel cell mode and electrolysis mode by: defining a highly conductive pathway for transfer of electrical energy between the electrode(s) and the interconnect and thereby reducing interfacial resistance; limiting or eliminating delamination and/or corrosion at the oxygen electrode that occurs while the fuel cell stack is operated in the electrolysis mode (e.g., by increasing porosity and preventing pO₂ buildup); exhibiting chemical and structural stability within RSOFC operating conditions; and strongly bonding (e.g., physically and electrically) with both the interconnect and electrode materials.

### 4. Contact Material: Contact Layer in a Fuel Cell Stack

The contact material 100 is configured to form a contact layer 102 in a fuel cell stack (e.g., a reversible solid-oxide fuel cell stack) including an electrode formed of an electrode material (e.g., La_{0.3}Ca_{0.7}Fe_{0.7}Cr_{0.3}O_{3-δ}), an interconnect formed of an interconnect material (e.g., Crofer 22 APU ferritic stainless steel), and the contact layer 102 formed of the contact material 100. The contact material 100 can therefore be configured to exhibit properties—such as related to electrical conductivity, thermal expansion, reactivity, chemical compatibility, and/or sintering behaviors—matched to these electrode and interconnect materials, in order to enable long-term, high-efficiency performance of the cell stack 104.

In one implementation, the contact material 100 is configured to form a set of contact layers 102 in a reversible solid-oxide fuel cell stack 104. In this implementation, the reversible solid-oxide fuel cell stack can include: a first fuel cell including a first oxygen electrode and a first fuel electrode; a second fuel cell including a second oxygen electrode and a second fuel electrode; and an interconnect arranged between the first and second fuel cell units and configured to electrically couple the first and second fuel cell units. The interconnect can include a contact layer 102—formed of the contact material 100—arranged across each surface of the interconnect abutting an electrode of these fuel cells. For example, the reversible solid-oxide fuel cell stack can include a first fuel cell, in a set of fuel cells, including: a first electrolyte; a first oxygen electrode, in a set of oxygen electrodes, arranged across a first surface of the first electrolyte; and a first fuel electrode, in a set of fuel electrodes, arranged across a second surface, opposite the first surface, of the first electrolyte. The reversible solid-oxide fuel cell stack can further include a second fuel cell including: a second electrolyte; a second oxygen electrode, in the set of oxygen electrodes, arranged across a third surface of the second electrolyte; and a second fuel electrode, in the set of fuel electrodes, arranged across a fourth surface, opposite the third surface, of the second electrolyte. The reversible solid-oxide fuel cell stack can include: an interconnect arranged between the second surface of the first fuel cell and the third surface of the second fuel cell; a first contact layer 102, in the set of contact layers 102, arranged between the interconnect and the second surface of the first fuel cell unit and configured to electrically couple the interconnect to the first fuel electrode; and a second contact layer 102, in the set of contact layers 102, arranged between the interconnect and the third surface of the second fuel cell unit and configured to electrically couple the interconnect to the second oxygen electrode.

In the preceding implementation, the contact material 100 and resulting contact layer 102—arranged between the interconnect and the fuel cell and formed of the contact material 100—can be configured to: transfer electrical energy between the interconnect and the electrode; exhibit sintering activity corresponding to sintering activity of the interconnect and the electrode; exhibit less than a threshold reactivity with the interconnect and the electrode; and exhibit thermal expansion properties corresponding to thermal expansion properties of the interconnect and the electrode. For example, the contact material 100 can be configured to: exhibit an electrical conductivity greater than 200 Siemens-per-centimeter at temperatures within a temperature range of 700 degrees Celsius to 1300 degrees Celsius; exhibit no adverse reactivity with the interconnect and/or electrode materials within a target temperature range, such as based on absence of a change in crystal structure (e.g., a rhombohedral crystal structure) and/or absence of formation of secondary crystal structures in the contact material 100—when mixed with the electrode and/or interconnect materials—when held at a target temperature (e.g., 800 degrees Celsius) over a target duration (e.g., 120 hours); and exhibit a thermal expansion coefficient—within a first threshold deviation of a second thermal expansion coefficient of the electrode material and within a second threshold deviation of a third thermal expansion coefficient of the interconnect material at the target temperature—between 10.0×10⁻⁶K⁻¹ and 15.0×10⁻⁶K⁻¹ at temperatures between 25 degrees Celsius and 1100 degrees Celsius.

Therefore, the contact material 100 can be configured to exhibit: an electrical conductivity exceeding a threshold electrical conductivity (e.g., 20 Siemens-per-centimeter, 50 Siemens-per-centimeter, 100 Siemens-per-centimeter) at temperatures within a target temperature range (e.g., between 25 degrees Celsius and 1300 degrees Celsius); a target thermal expansion coefficient within a threshold deviation of both the thermal expansion coefficients of the interconnect and electrode materials, such as within a threshold deviation of an average thermal expansion coefficient of the interconnect and electrode materials; a stable crystal structure at relatively high temperatures (e.g., exceeding 1000 degrees Celsius), such as during operation of the fuel cell stack; and chemical compatibility with the interconnect and electrode materials in order to improve performance of the cell stack.

### 4.1 Contact Material: Composition

In one implementation, the contact material 100 includes a base material (e.g., LaNiO_{3-δ}) including a first amount of Lanthanum, a second amount of Nickel, and a third amount of Oxygen. This base material can exhibit high electrical conductivity (e.g., at temperatures within a target temperature range), such that the resulting contact material 100 exhibits relatively high electrical conductivity.

Additionally, in this implementation, the base material can be doped with additional metals (or “doping agents”) configured to: increase stability of the cell stack—by stabilizing a crystal structure (e.g., a perovskite structure) of the base material—at relatively high temperatures (e.g., at and/or exceeding 800 degrees Celsius), such as during operation of the cell stack 104; limit thermal expansion of the resulting contact material 100, such as by regulating a thermal expansion coefficient of the contact material 100 to within a threshold deviation of thermal expansion coefficients of the electrode material and interconnect materials; and/or maintain relatively high electrical conductivity of the contact material 100 to enable transfer of electrical energy between the electrode, interconnect, and/or opposite electrode, through the contact layer 102 formed of the contact material 100. For example, the base material can include amounts of Cobalt (or “Co”), Iron (or “Fe”), Copper (or “Cu”), and/or Chromium (or “Cr”) as a doping agent (or “dopant”) doped onto the base material.

In one implementation, the contact material 100 can include Cobalt as a doping agent in the base mixture. In particular, in this implementation, the contact material 100 can include: a base material including a first amount of Lanthanum, a second amount of Nickel, a fourth amount of Oxygen, and a third amount of Cobalt configured to stabilize the base material. In particular, this third amount of Cobalt can be configured to stabilize the perovskite structure of the resulting contact material 100 at temperatures exceeding 1000 degrees Celsius, such as during operation of a fuel cell stack 104 including the contact material 100. Additionally, in this implementation, the contact material 100 can include a fifth amount of a doping agent—such as Iron, Copper, and/or Chromium—configured to limit thermal expansion of the base material.

For example, the contact material 100 can include: a first amount of Lanthanum; a second amount of Nickel defining a first stoichiometric ratio of the second amount of Nickel to the first amount of Lanthanum of 0.6; a fourth amount of Oxygen defining a third stoichiometric ratio of the fourth amount of Oxygen to the first amount of Lanthanum of 3; a third amount of Cobalt defining a second stoichiometric ratio of the third amount of Cobalt to the first amount of Lanthanum of 0.2; a fifth amount of Iron defining a fourth stoichiometric ratio of the fifth amount of Iron to the first amount of Lanthanum of 0.2. In particular, in this example, the contact material 100 includes LaNi_{0.6}Co_{0.2}Fe_{0.2}O_{3-δ} and exhibits: a thermal expansion coefficient value between 10.0×10⁻⁶K⁻¹ and 15.0×10⁻⁶K⁻¹ at temperatures between 25 degrees Celsius and 900 degrees Celsius; and an electrical conductivity value exceeding 380 Siemens-per-centimeter at 800 degrees Celsius.

Alternatively, in another example, the contact material 100 can include: a first amount of Lanthanum; a second amount of Nickel defining a first stoichiometric ratio of the second amount of Nickel to the first amount of Lanthanum of 0.6; a fourth amount of Oxygen defining a third stoichiometric ratio of the fourth amount of Oxygen to the first amount of Lanthanum of 3; a third amount of Cobalt defining a second stoichiometric ratio of the third amount of Cobalt to the first amount of Lanthanum of 0.3; and a fifth amount of Iron defining a fourth stoichiometric ratio of the fifth amount of Iron to the first amount of Lanthanum of 0.1. In particular, in this example, the contact material 100 includes LaNi_{0.6}Co_{0.3}Fe_{0.1}O_{3-δ} and exhibits: a thermal expansion coefficient value between 10.0×10⁻⁶K⁻¹ and 15.0×10⁻⁶K⁻¹ at temperatures between 25 degrees Celsius and 900 degrees Celsius; and an electrical conductivity value exceeding 600 Siemens-per-centimeter at 800 degrees Celsius.

Additionally and/or alternatively, in another implementation, the contact material 100 can include Iron as a doping agent in the base mixture. In particular, in this implementation, the contact material 100 can include: a base material including a first amount of Lanthanum, a second amount of Nickel, a fourth amount of Oxygen, and a third amount of Iron configured to stabilize the base material. In particular, this third amount of Iron can be configured to stabilize the perovskite structure of the resulting contact material 100 at temperatures exceeding 1000 degrees Celsius, such as during operation of a fuel cell stack 104 including the contact material 100. Additionally, in this implementation, the contact material 100 can include a fifth amount of a doping agent—such as Copper and/or Chromium—configured to limit thermal expansion of the base material.

For example, the contact material 100 can include: a first amount of Lanthanum; a second amount of Nickel defining a first stoichiometric ratio of the second amount of Nickel to the first amount of Lanthanum of 0.6; a fourth amount of Oxygen defining a third stoichiometric ratio of the fourth amount of Oxygen to the first amount of Lanthanum of 3; a third amount of Iron defining a second stoichiometric ratio of the third amount of Iron to the first amount of Lanthanum of 0.2; a fifth amount of Copper defining a fourth stoichiometric ratio of the fifth amount of Copper to the first amount of Lanthanum of 0.2. In particular, in this example, the contact material 100 includes LaNi_{0.6}Fe_{0.2}Cu_{0.2}O_{3-δ} and exhibits: a thermal expansion coefficient value between 10.0×10⁻⁶K⁻¹ and 15.0×10⁻⁶K⁻¹ at temperatures between 25 degrees Celsius and 1100 degrees Celsius; and an electrical conductivity value exceeding 240 Siemens-per-centimeter at 800 degrees Celsius.

Alternatively, in another example, the contact material 100 can include: a first amount of Lanthanum; a second amount of Nickel defining a first stoichiometric ratio of the second amount of Nickel to the first amount of Lanthanum of 0.6; a fourth amount of Oxygen defining a third stoichiometric ratio of the fourth amount of Oxygen to the first amount of Lanthanum of 3; a third amount of Iron defining a second stoichiometric ratio of the third amount of Iron to the first amount of Lanthanum of 0.3; and a fifth amount of Copper defining a fourth stoichiometric ratio of the fifth amount of Copper to the first amount of Lanthanum of 0.1. In particular, in this example, the contact material 100 includes LaNi_{0.6}Fe_{0.3}Cu_{0.1}O_{3-δ} and exhibits: a thermal expansion coefficient value between 10.0×10⁻⁶K⁻¹ and 15.0×10⁻⁶K⁻¹ at temperatures between 25 degrees Celsius and 1100 degrees Celsius; and an electrical conductivity value exceeding 270 Siemens-per-centimeter at 800 degrees Celsius.

### 5. Contact Material: Examples

In the examples described below, the contact material 100 is configured to form a contact layer 102 in a cell stack 104 including an electrode formed of an electrode material, an interconnect formed of an interconnect material, and the contact layer 102 formed of the contact material 100.

In these examples, the interconnect material includes Crofer 22 APU. Generally, the interconnect material exhibits an average TEC between 11.8 (×10⁻⁶K⁻¹) and 12.8 (×10⁻⁶K⁻¹). Further, in these examples, the electrode material includes La_{0.3}Ca_{0.7}Fe_{0.7}Cr_{0.3}O_{3δ} (hereinafter “LCFCr”). Generally, the electrode material exhibits an average TEC between 11.5 (×10⁻⁶K⁻¹) and 12 (×10⁻⁶K⁻¹). However, the contact material 100 can be configured to form a contact layer 102 forming an interface between any type and/or variation of the electrode material and/or the interconnect material.

Therefore, the contact material 100 can be configured to exhibit an average TEC within a threshold deviation (e.g., five percent, twenty percent) of the average TEC of both the electrode material and the interconnect material in order to minimize delamination, deformation, and fracture issues during thermal cycling of the cell stack 104. Additionally, the contact material 100 can be configured to exhibit relatively high electrical conductivity values—and relatively low total interfacial ohmic resistance—such that the contact material 100 enables high electrochemical performance of the RSOFC.

The contact material 100 can be formed of a base material including LaNiO_{3-δ} and exhibiting high electrical conductivity, such that the contact material 100 exhibits relatively high electrical conductivity. This base material can be doped with additional metals (or “doping agents”) configured to increase stability of the cell stack 104—by stabilizing a crystal structure (e.g., a perovskite structure) of the base material—at high temperatures (e.g., greater than 1000 degrees Celsius), such as during operation of the cell stack 104.

In one implementation, as described above, the contact material 100 can include Cobalt as a doping agent in the base mixture. In this implementation, the base material (e.g., the Nickel in the base material) can be doped with Cobalt to stabilize the perovskite structure of the resulting contact material 100 at temperatures exceeding 1000 degrees Celsius. Additionally and/or alternatively, in another implementation, as described above, the contact material 100 can include Iron as a doping agent in the base mixture. In this implementation, the base material (e.g., the Nickel in the base material) can be doped with Iron to stabilize the perovskite structure of the resulting contact material 100 at temperatures exceeding 1000 degrees Celsius.

Therefore, in the following examples, the contact materials 100 include LaNi₁₋ₓCoₓO_{3-δ} (hereinafter “LNC”), LaNi₁₋ₓFeₓO_{3-δ} (hereinafter “LNF”), and/or derivatives of these contact materials 100 as further described below.

As described in the examples below, the LNC contact material 100 was doped with Fe, Cr, and/or Cu in order to reduce the average TEC of the LNC contact material 100. Similarly, the LNF contact material 100 was doped with Cr and/or Cu to reduce the average TEC of the LNF contact material 100.

### 5.1 Example 1: LNF Contact Material

In one implementation, the contact material 100 includes LaNi₁₋ₓFeₓO_{3-δ} (hereinafter the “LNF contact material 100”), where x is between 0 and 0.4 (e.g., 0, 0.1, 0.2, 0.3, and 0.4).

In this first example, the contact material 100 includes LaNi₁₋ₓFeₓO_{3-δ}, where x is 0.4. Therefore, the contact material 100 includes LaNi_{0.6}Fe_{0.4}O_{3-δ}. In this example, the contact material 100 including LaNi_{0.6}Fe_{0.4}O_{3-δ} (e.g., LaN₁₋ₓFeₓO_{3-δ} where x is 0.4) exhibits a greater electrical conductivity than each of the other LNF contact materials 100.

### 5.1.1 Synthesis and Characterization

The contact materials 100 were synthesized via a glycine-nitrate combustion method. In particular, to generate each contact materials 100, metal nitrate precursors were mixed in stoichiometric proportions and dissolved in deionized water. Glycine (a 2:1 mole ratio of glycine to the total cation content) was added to the nitrate solution. The solution was slowly stirred on a hot plate until auto-ignition and self-sustaining combustion occurred to form fine powders. The fine powders were then ground and calcined in air between 800-1200 degrees Celsius for 5-10 hours, where temperature and time varied depending on the composition.

Materials were purchased from Alfa Aesar as follows: Glycine (99.5%); La(NO₃)₃.6H₂O (99.9%); Sr(NO₃)₂ (99.0%); Ca(NO₃)₂.4H₂O (99.0%); Cr(NO).9H₂O (98.5%); Fe(NO₃)₃.9H₂O (98-101%); Ni(NO₃)₂.6H₂O (98.0%); Co(NO₃)₂.6H₂O (98.0-102.0%); and Cu(NO₃)₂.2.5H₂O (98.0-100%).

X-ray diffraction (hereinafter “XRD”) patterns of all samples synthesized in this example were collected using Bruker D8 Advance powder X-ray diffractometers (PXRD) with Cu Kα monochromatic radiation (λ=1.54056 Δ). The diffractometer was equipped with a primary monochromator of Johansson Type generating Kα₁-radiation, operating at 45 kV and 40 mA. XRD patterns were collected in the 2θ range of 10-80° at room temperature with a step size of 0.03° and 10-second counting time in order to ensure sufficient resolution for structural refinement.

Powder X-ray Thermodiffraction patterns were collected on an X'Pert PRO MPD diffractometer with a high temperature reactor chamber Anton Paar HTK1200 camera, using Cu Kα radiation. The measurements were carried out between room temperature and 1100° C. The standard working conditions were a 2θ range of 10-80° with an angle step size of 0.0330 and a 25 s counting time. The sample was heated to the target temperatures at a ramp rate of 5° C./min and stabilized in air for 40 min prior to the measurements. After heating, the sample was cooled to RT and XRD patterns were acquired again in order to determine the phase stability of the LCFCr and contact material 100 under heating and cooling conditions.

Conventional Rietveld method using the General Structure Analysis System (GSAS) package with the graphical user interface (EXPGUI) software was employed to carry out structural refinements from XRD patterns. Where, zero shift, background, scale factor, lattice parameters, atomic positions, thermal parameters, and profile coefficients for the Pseudo-Voigt/Finger, Cox, and Jephcoat (FCJ) asymmetric peak shape function were all refined until convergent.

### 5.1.2 System Fabrication and Study

The contact material 100 was applied (e.g., pasted) across a surface of a coupon (e.g., a 1-cm×1-cm section) of the interconnect material (e.g., Crofer 22 APU). This coupon—including the applied contact material 100 was then dried in an oven. The electrode material (e.g., LCFCr) was then applied (e.g., pasted) over the contact material 100, opposite the interconnect material, to form a stack 104 including: a layer of the electrode material; a layer of the contact material 100 contacting the layer of the electrode material; and a layer of the interconnect material contacting the layer of the contact material 100 opposite the layer of the electrode material.

### 5.1.3 Example 1: Results

To analyze structural stability of a cell stack 104 including the contact material 100, a delamination test was performed. In the delamination test, the cell stack 104 was heated at 800 degrees Celsius for 75 hours at a heating and cooling rate of 1 degree/minute. Delamination of the contact materials 100 was then inspected (e.g., visually inspected) after this 75-hour heating period. For each of the LNF contact materials 100, no delamination was visually detected.

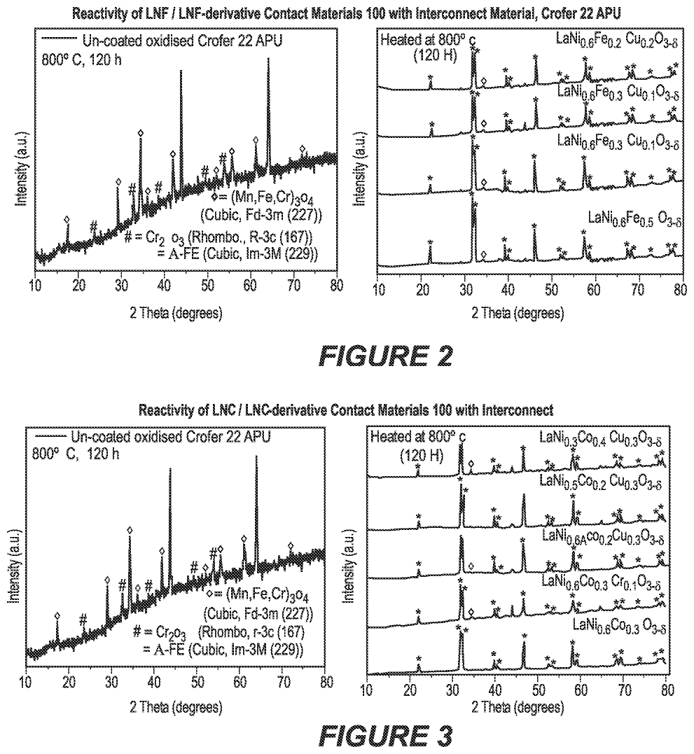

To characterize reactivity of the LNF contact material 100 with the interconnect material, XRD analysis was performed. Coupons of the electrode material—coated with the contact material 100—were heated at 800 degrees Celsius in air for 120 hours. After heat treatment, XRD patterns of these coupons were collected. As shown in FIG. 2, no additional peaks were detected in the XRD patterns when compared to XRD patterns of the contact material 100 and XRD patterns of the interconnect material. Therefore, the XRD patterns of the coupons indicate that no reaction occurred between the contact material 100 and the interconnect material. Further, XRD peaks attributed to the interconnect material were detected in each XRD pattern collected, indicating that X-rays were able to penetrate the contact material 100.

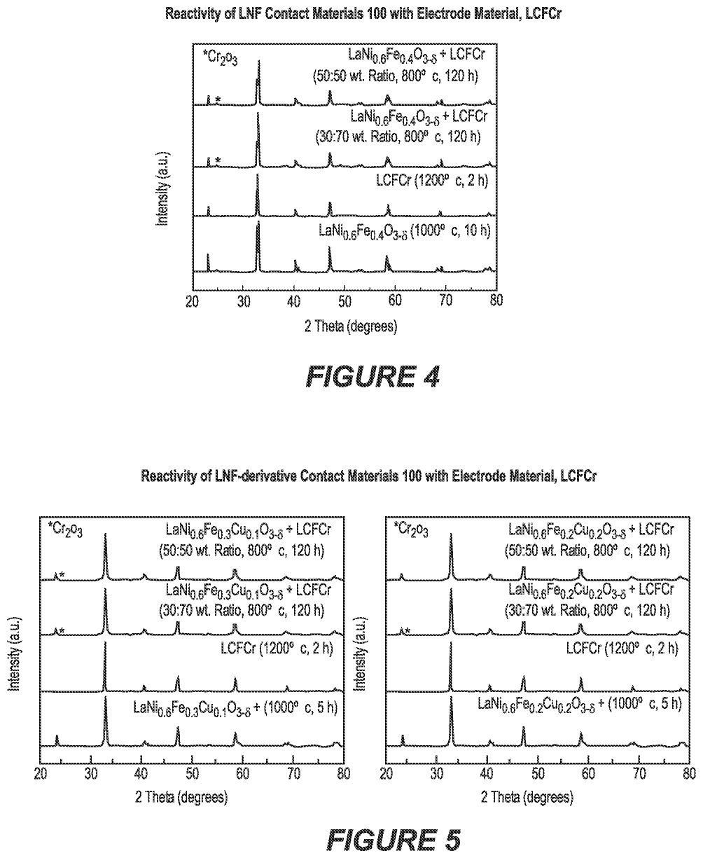

To characterize reactivity of the LNF contact material 100 with the electrode material (e.g., LCFCr), XRD analysis was performed. Powder of the contact material 100 were mixed with the LCFCr electrode powder at a 50:50 weight ratio, and 30:70 weight ratio, and were heated at 800 degrees Celsius in air for 120 hours. In one example, the LNF contact material 100 and LCFCr electrode material were combined at a 50:50 weight ratio. In a second example, the contact material 100 and LCFCr electrode material were combined at a 30:70 weight ratio. After heat treatment, XRD patterns of these powders were collected. As shown in FIG. 4, no additional peaks were detected in the XRD patterns when compared to XRD patterns of the LNF contact material 100 and XRD patterns of the electrode material (e.g., LCFCr). Therefore, the XRD patterns of the combined heat treated powders indicate that no reaction occurred between the LNF contact material 100 and the electrode material.

The LNF contact materials 100 were sintered at high temperatures (e.g., temperatures between 800 degrees Celsius and 1300 degrees Celsius) to evaluate electrical conductivity of these contact materials 100 at different temperatures. In this example, the LNF contact material 100 was sintered at 1300 degrees Celsius for five hours. The LNF contact material 100 exhibited an average electrical conductivity (σ₈₀₀) of 482 S/cm.

Table 1 lists average thermal expansion coefficients of the LNF contact material 100 calculated from the thermal XRD data.

TABLE 1
Average Thermal Expansion Coefficient
(TEC) for LNF Contact material 100

| Thermal Expansion Parameters | Average TEC (×10⁻⁶K⁻¹) | |
|---|---|---|
| Lattice Parameter (a) | 9.69 | (25-1100° C.) |
| Lattice Parameter (c) | 19.66 | (25-1100° C.) |
| Average TEC | 14.67 | (25-1100° C.) |

As shown in TABLE 1, the average TEC of the LNF contact material 100 is higher than the average TEC of the interconnect and electrode materials. However, the LNF material exhibits a relatively high electrical conductivity.

### 5.2 Example 2: LNF-Cu Contact Material

In this example, the LNF contact material 100 of Example 1 was doped with Copper at varying concentrations to generate a Cu-doped LNF contact material 100 (hereinafter “LNF-Cu contact material 100”). In this example, the LNF-Cu contact material 100 includes LaNi_{0.6}Fe_{0.4-x}CuₓO_{3-δ} (x=0, 0.1, 0.2, 0.3, 0.4).

In this example, the LNF-Cu contact material 100 was formed according to the glycine-nitrate method described in Example 1. To characterize reactivity of the LNF-Cu contact material 100 with the interconnect material, XRD analysis was performed according to the method described in Example 1. As shown in FIG. 2, no additional peaks were detected in the XRD patterns when compared to XRD patterns of the LNF-Cu contact material 100 and XRD patterns of the interconnect material (e.g., Crofer 22 APU). Further, XRD peaks attributed to the interconnect material were detected in each collected XRD pattern, indicating that X-rays were able to penetrate the LNC-Cu contact material 100.

To characterize reactivity of the LNF-Cu contact material 100 with the electrode material (e.g., LCFCr), XRD analysis was performed according to the method described in Example 1. As shown in FIG. 5, no additional peaks were detected in the XRD patterns when compared to XRD patterns of the LNF-Cu contact material 100 and XRD patterns of the electrode material. Therefore, the XRD patterns of the combined heat treated powders indicate that no reaction occurred between the LNF-Cu contact material 100 and the electrode material.

The LNF-Cu contact materials 100 were sintered at high temperatures (e.g., temperatures between 800 degrees Celsius and 1300 degrees Celsius) to evaluate electrical conductivity of these LNF-Cu contact materials 100 at different temperatures. In this example, the LNF-Cu contact material 100 was sintered at 1000 degrees Celsius for five hours. The LNF-Cu contact material 100 exhibited an average electrical conductivity ((σ₈₀₀) of 249 S/cm.

TABLE 2 lists average thermal expansion coefficients of the contact material 100 including LaNi_{0.6}Fe_{0.2}Cu_{0.2}O₃₆ calculated from the thermal XRD data.

TABLE 2
Average Thermal Expansion Coefficient
(TEC) for LNF-Cu Contact material 100

| Thermal Expansion Parameters | Average TEC (×10⁻⁶K⁻¹) | |
|---|---|---|
| Lattice Parameter (a) | 8.66 | (25-700° C.) |
| Lattice Parameter (c) | 17.88 | (25-700° C.) |
| Average TEC | 13.27 | (25-700° C.) |

As indicated in TABLE 2, the LNF-Cu contact material 100 exhibits a lower average TEC than the LNF contact material 100. However, the LNF-Cu contact material 100 exhibits a lower average electrical conductivity than the LNF contact material 100.

### 5.3 Example 3: LNF-Cr Contact Material

In this example, the LNF contact material 100 of Example 1 was doped with Chromium at varying concentrations to generate a Cr-doped LNF contact material 100 (hereinafter “LNF-Cr contact material 100”). In this example, the LNF-Cr contact material 100 includes LaNi_{0.6}Fe_{0.3}Cr_{0.1}O_{3-δ}.

To characterize reactivity of the LNF-Cr contact material 100 with the interconnect material, XRD analysis was performed according to the method described in Example 1. As shown in FIG. 2, no additional peaks were detected in the XRD patterns when compared to XRD patterns of the LNF-Cr contact material 100 and XRD patterns of the interconnect material. Further, XRD peaks attributed to the interconnect material were detected in each XRD pattern collected, indicating that X-rays were able to penetrate the LNF-Cr contact material too.

The LNF-Cr contact materials too were sintered at high temperatures to evaluate electrical conductivity of these LNF-Cr contact materials 100 at different temperatures. In this example, the LNF-Cr contact material 100 was sintered at 1300 degrees Celsius for five hours. The LNF-Cr contact material 100 exhibited an average electrical conductivity (σ₈₀₀) of 277 S/cm.

TABLE 3 lists average thermal expansion coefficients of the LNF-Cr contact material 100 calculated from the thermal XRD data.

TABLE 3
Average Thermal Expansion Coefficient
(TEC) for LNF-Cr Contact material 100

| Thermal Expansion Parameters | Average TEC (×10⁻⁶K⁻¹) | |
|---|---|---|
| Lattice Parameter (a) | 8.81 | (25-900° C.) |
| Lattice Parameter (c) | 17.95 | (25-900° C.) |
| Average TEC | 13.38 | (25-900° C.) |

As indicated in TABLE 3, the LNF-Cr contact material 100 exhibits a lower average TEC than the LNF contact material 100. However, LNF-Cr contact material 100 exhibits a lower average electrical conductivity than the LNF contact material 100. Additionally, the LNF-Cr contact material 100 exhibits a higher average TEC than the LNF-Cu contact material too and a higher average electrical conductivity than LNF-Cu contact material too.

### 5.4 Example 4: LNC Contact Material

In one implementation, the contact material 100 includes LaNi_{1-z}CoₓO_{3-δ} (hereinafter the “LNC contact material 100”), where x is between 0 and 0.4 (e.g., 0, 0.1, 0.2, 0.3, and 0.4). In this example, the contact material 100 includes LaNi_{0.6}Co_{0.4}O_{3-δ}.

In this example, the contact material 100 was formed according to the glycine-nitrate method described in Example 1. To analyze structural stability of a cell stack 104 including the contact material 100, a delamination test was performed according to the method described in Example 1. For each of the LNC contact materials 100, no delamination was visually detected.

To characterize reactivity of the LNC contact material 100 with the interconnect material, XRD analysis was performed according to the method described in Example 1. As shown in FIG. 3, no additional peaks were detected in the XRD patterns when compared to XRD patterns of the LNC contact material 100 and XRD patterns of the interconnect material. Therefore, the XRD patterns of the coupons indicate that no reaction occurred between the LNC contact material 100 and the interconnect material. Further, XRD peaks attributed to the interconnect material were detected in each XRD pattern collected, indicating that X-rays were able to penetrate the LNC contact material 100.

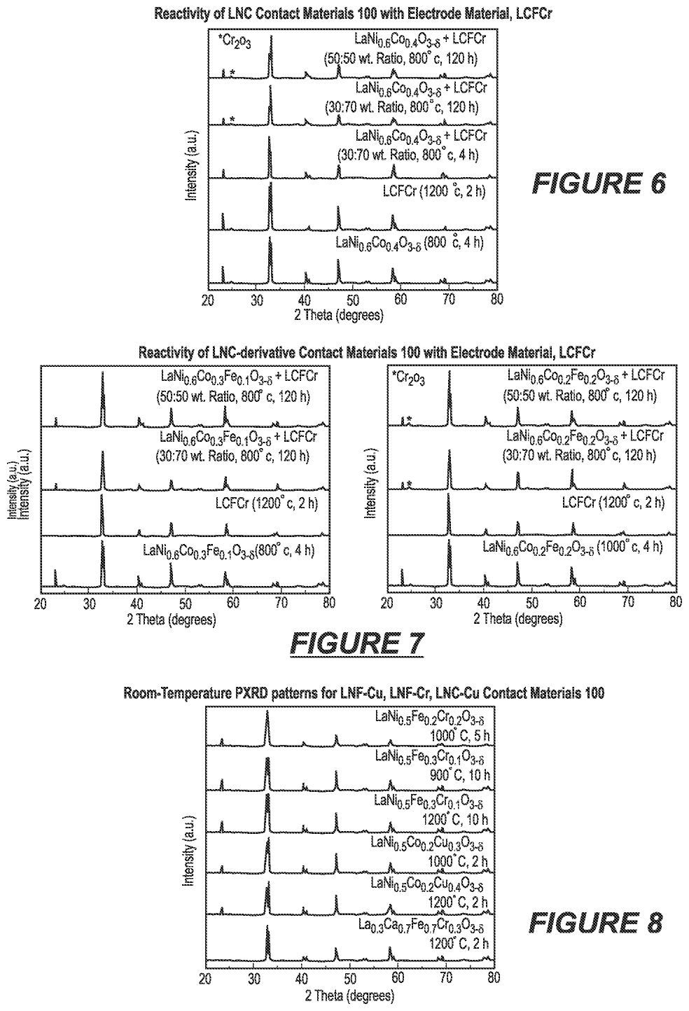

To characterize reactivity of the LNC contact material 100 with the electrode material (e.g., LCFCr), XRD analysis was performed according to the method described in Example 1. As shown in FIG. 6, no additional peaks were detected in the XRD patterns when compared to XRD patterns of the LNC contact material 100 and XRD patterns of the electrode material. Therefore, the XRD patterns of combined heat treated powders indicate that no reaction occurred between the LNC contact material 100 and the electrode material.

The LNC contact materials 100 were sintered at high temperatures to evaluate electrical conductivity of these contact materials 100 at different temperatures. In this example, the LNC contact material 100 was sintered at 1300 degrees Celsius for five hours, 1200 degrees Celsius for 5 hours, and at 1150 degrees Celsius for five hours. The LNC contact material 100 exhibited an average electrical conductivity (σ₈₀₀) greater than 550 S/cm. Therefore, the LNC contact material 100 exhibited a higher average electrical conductivity than the LNF contact material 100 and corresponding LNC derivatives (e.g., LNC-Cu, LNC-Cr contact materials 100).

### 5.5 Example 5: LNC-Cu Contact Material

In this example, the LNC contact material 100 of Example 4 was doped with Copper at varying concentrations to generate a Cu-doped LNC contact material 100 (hereinafter “LNC-Cu contact material 100”). In this example, the LNC-Cu contact materials 100 include LaNi_{0.6}Co_{0.2}Cu_{0.2}O_{3-δ}, LaNi_{0.5}Co_{0.2}Cu_{0.3}O_{3-δ}, and LaNi_{0.3}Co_{0.4}Cu_{0.3}O_{3-δ}.

To characterize reactivity of the LNC-Cu contact material 100 with the interconnect material, XRD analysis was performed according to the method described in Example 1. As shown in FIG. 3, no additional peaks were detected in the XRD patterns when compared to XRD patterns of the LNC-Cu contact material 100 and XRD patterns of the interconnect material. Further, XRD peaks attributed to the interconnect material were detected in each XRD pattern collected, indicating that X-rays were able to penetrate the LNC-Cu contact material 100.

The LNC-Cu contact materials 100 were sintered at high temperatures to evaluate electrical conductivity of these LNC-Cu contact materials 100 at different temperatures. In one example, the LNC-Cu contact material 100 was sintered at 1300 degrees Celsius for five hours. In a second example, the LNC-Cu contact material 100 was sintered at 1200 degrees Celsius for five hours. In a third example, the LNC-Cu contact material 100 was sintered at 1150 degrees Celsius for five hours. The LNC-Cu contact material 100 including LaNi_{0.6}Co_{0.2}Cu_{0.2}O_{3-δ} exhibited an average electrical conductivity (σ₈₀₀) of 539 S/cm. The LNC-Cu contact material 100 including LaNi_{0.5}Co_{0.2}Cu_{0.3}O_{3-δ} exhibited an average electrical conductivity (σ₈₀₀) of 406 S/cm. The LNC-Cu contact material 100 including LaNi_{0.3}Co_{0.4}Cu_{0.3}O_{3-δ} exhibited an average electrical conductivity (σ₈₀₀) of 532 S/cm.

### 5.6 Example 6: LNC-Cr Contact Material

In this example, the LNC contact material 100 of Example 4 was doped with Chromium at varying concentrations to generate a Cr-doped LNC contact material 100 (hereinafter “LNC-Cr contact material 100”). In this example, the LNC-Cr contact materials 100 include LaNi_{0.6}Co_{0.3}Cr_{0.1}O_{3-δ}, LaNi_{0.6}Co_{0.2}Cr_{0.2}O_{3-δ}, and LaNi_{0.6}Co_{0.1}Cr_{0.3}O_{3-δ}.

To characterize reactivity of the LNC-Cr contact material 100 with the interconnect material, XRD analysis was performed according to the method described in Example 1. As shown in FIG. 3, no additional peaks were detected in the XRD patterns when compared to XRD patterns of the LNC-Cr contact material 100 and XRD patterns of the interconnect material. Further, XRD peaks attributed to the interconnect material were detected in each XRD pattern collected, indicating that X-rays were able to penetrate the LNC-Cr contact material 100.

The LNC-Cr contact materials 100 were sintered at high temperatures to evaluate electrical conductivity of these LNC-Cr contact materials 100 at different temperatures. In one example, the LNC-Cr contact material 100 was sintered at 1300 degrees Celsius for five hours. In a second example, the LNC-Cr contact material 100 was sintered at 1200 degrees Celsius for five hours. The LNC-Cr contact material 100 including LaNi_{0.6}Co_{0.1}Cr_{0.3}O_{3-δ} exhibited an average electrical conductivity (σ₈₀₀) of 174 S/cm.

TABLE 4 lists average thermal expansion coefficients of the LNC-Cr contact material 100 including LaNi_{0.6}Co_{0.1}Cr_{0.3}O_{3-δ} calculated from the thermal XRD data.

TABLE 4
Average Thermal Expansion Coefficient
(TEC) for LNC-Cr Contact material 100

| Thermal Expansion Parameters | Average TEC (×10⁻⁶K⁻¹) | |
|---|---|---|
| Lattice Parameter (a) | 9.66 | (25-1100° C.) |
| Lattice Parameter (c) | 20.64 | (25-1100° C.) |
| Average TEC | 15.15 | (25-1100° C.) |

As indicated in TABLE 4, the LNC-Cr contact material 100 exhibits a higher average TEC than the LNF contact material 100 and the corresponding derivatives (e.g., LNF-Cu, LNF-Cr). Further, the LNC-Cr contact material 100 exhibits a lower electrical conductivity than the LNC-Cu contact material 100 and the LNF contact materials 100 and corresponding derivatives.

### 5.7 Example 2: LNCFe Contact Material

In this example, the LNC contact material 100 of Example 4 was doped with Iron at varying concentrations to generate an Fe-doped LNC contact material 100 (hereinafter “LNC-Fe contact material 100”). In this example, the LNC-Fe contact materials 100 include LaNi_{0.6}Co_{0.3}Fe_{0.1}O_{3-δ}, LaNi_{0.6}Co_{0.2}Fe_{0.2}O_{3-δ}, and LaNi_{0.6}Co_{0.1}Fe_{0.3}O_{3-δ}.

To characterize reactivity of the LNC-Fe contact material 100 with the interconnect material, XRD analysis was performed according to the method described in Example 1. As shown in FIG. 3, no additional peaks were detected in the XRD patterns when compared to XRD patterns of the LNC-Fe contact material 100 and XRD patterns of the interconnect material. Further, XRD peaks attributed to the interconnect material were detected in each XRD pattern collected, indicating that X-rays were able to penetrate the LNC-Fe contact material 100.

The LNC-Fe contact materials 100 were sintered at high temperatures to evaluate electrical conductivity of these LNC-Fe contact materials 100 at different temperatures. In this example, the LNC-Fe contact material 100 including LaNi_{0.6}Co_{0.2}Fe_{0.2}O_{3-δ} was sintered at 1300 degrees Celsius for five hours and at 1200 degrees Celsius for five hours. The LNC-Fe contact material 100 including LaNi_{0.6}Co_{0.2}Fe_{0.2}O_{3-δ} exhibited an average electrical conductivity (σ₈₀₀) of 394 S/cm.

To characterize reactivity of the LNC-Fe contact material 100 with the electrode material (e.g., LCFCr), XRD analysis was performed according to the method described in Example 1. As shown in FIG. 7, no additional peaks were detected in the XRD patterns when compared to XRD patterns of the LNC-Fe contact material 100 and XRD patterns of the interconnect material. Therefore, the XRD patterns of the combined heat treated powders indicate that no reaction occurred between the LNC-Fe contact material 100 and the electrode material.

TABLE 5 lists average thermal expansion coefficients of the LNC-Fe contact material 100 including LaNi_{0.6}Co_{0.2}Fe_{0.2}O_{3-δ} calculated from the thermal XRD data.

TABLE 5
Average Thermal Expansion Coefficient
(TEC) for LNC-Fe Contact material 100

| Thermal Expansion Parameters | Average TEC (×10⁻⁶K⁻¹) | |
|---|---|---|
| Lattice Parameter (a) | 9.52 | (25-1100° C.) |
| Lattice Parameter (c) | 20.44 | (25-1100° C.) |
| Average TEC | 14.98 | (25-1100° C.) |

As indicated in TABLE 5, the LNC-Fe contact material 100 exhibits a higher average TEC than the LNF contact material 100 and the corresponding derivatives (e.g., LNF-Cu, LNF-Cr). The LNC-Fe contact material 100 exhibits a higher electrical conductivity than the LNC-Cr contact material 100 and a lower electrical conductivity than the LNC-Cu contact material 100.

### 5.8 Example 8: LNF-Cu, LNF-Cr, & LNC-Cu Contact Materials

In one example, the LNF-Cu, LNF-Cr, and LNC-Cu contact materials 100 were compared. In particular, in the following example, the LNF-Cu contact material 100 includes LaNi_{0.6}Fe_{0.2}Cu_{0.2}O_{3-δ}. The LNF-Cr contact material 100 includes LaNi_{0.6}Fe_{0.3}Cr_{0.1}O_{3-δ}. The LNC-Cu contact material 100 includes LaNi_{0.5}Co_{0.2}Cu_{0.3}O_{3-δ}.

### 5.8.1 Example 8: Material Synthesis & Preparation

In this example, each of the contact materials 100, the interconnect material, and the electrode material were prepared via the glycine-nitrate combustion method. To synthesise the LNF-Cu contact material 100, La(NO₃)₂.6H₂O, Ni(NO₃)₂.6H₂O, Fe(NO₃)₃.9H₂O, and Cu(NO₃)₃.6H₂O were mixed and processed according to a set method. In particular, a stoichiometric amount of each metal nitrate was dissolved in deionized water. A 2:1 stoichiometric amount of glycine to the total molar content of nitrates was then added to the metal nitrate solution. The metal nitrate solution was then stirred thoroughly and heated on a hot plate at 375° C. until self-combustion occurred, forming a powder. The resulting powder was ground and further calcined at a particular calcination temperature to produce a single-phase powder.

To synthesise the LNF-Cr contact material 100, La(NO₃)₂.6H₂O, Ni(NO₃)₂.6H₂O, Fe(NO₃)₃.9H₂O, and Cr(NO₃)₃.9H₂O were mixed and processed according the set method described above. To synthesise the LNC-Cu contact material 100, La(NO₃)₂.6H₂O, Ni(NO₃)₂.6H₂O, Co(NO₃)₃.6H₂O, and Cu(NO₃)₃.6H₂O were mixed and processed according the set method described above. Finally, to synthesize the LCFCr electrode material, La(NO₃)₂.6H₂O, Ca(NO₃)₂.4H₂O, Fe(NO₃)₃.9H₂O, and Cr(NO₃)₃.9H₂O were mixed and processed according the set method described above.

Each resulting powder was combined with a pre-slurry mixture—including terpineol, benzyl butyl phthalate, butanol, and ethyl cellulose—to generate a slurry solution. Before mixing with the powder, the pre-slurry mixture was: initially heated to 80° C. under magnetic stirring; and removed from the heat and cooled to room temperature. The powder was then mixed with the pre-slurry mixture, in a mortar/pestle, at a weight ratio of 1:1.5 of the powder to the pre-slurry mixture.

In these examples, the interconnect material is formed of Crofer 22 APU ferritic stainless steel. In particular, the interconnect material includes: between 20 and 24 weight percent Cr; between 0.3 and 0.8 weight percent Mn; between 0.03 and 0.2 weight percent Ti; between 0.04 and 0.2 weight percent La; 0.003 weight percent C; 0.05 weight percent P; 0.020 weight percent S; and a remaining weight percent of Fe. The interconnect was: polished with a #600 grit SiC; cleaned via ultrasonication in a methanol solution for 15 minutes; cleaned via ultrasonication in an acetone solution for 15 minutes; and pre-oxidized at 820° C. over a 125-hour pre-oxidation period.

### 5.8.2 Example 7: Powder Characterization

Room temperature powder X-ray diffraction (PXRD) patterns of all samples were collected using Bruker D8 Advance X-ray diffractometers with Cu Kα monochromatic radiation (λ=1.54056 Å), operating at 45 kV and 40 mA. XRD patterns were collected in the 2θ range of 20-80° at room temperature with a step size of 0.02° and a one-second counting time.

Phase purity of the contact material 100 was characterized via PXRD analysis, as shown in FIG. 8. Each of the contact materials 100—including the LNF-Cu contact material 100, the LNF-Cr contact material 100, and the LNC-Cu contact material 100—were indexed with rhombohedral crystal structure assigned to the R-3c space group. Each of these contact materials 100 exhibited absence of additional peaks, secondary phases, and/or impurities. Therefore, each of the contact materials 100—including the LNF-Cu contact material 100, the LNF-Cr contact material 100, and the LNC-Cu contact material 100—exhibited stability at high temperatures (e.g., exceeding 1000 degrees Celsius).

### 5.8.3 Example 8: Chemical Compatibility

Reactivity between the contact material 100 and the LCFCr electrode material was characterized by: mixing powders of the contact material 100 and the LCFCr electrode material, via a mortar/pestle, at weight ratios of contact material 100 to LCFCr electrode material of 30:70 and 50:50; heating the mixed powders to 800° C. for 120 hours in air; and characterizing the mixed phases through XRD.

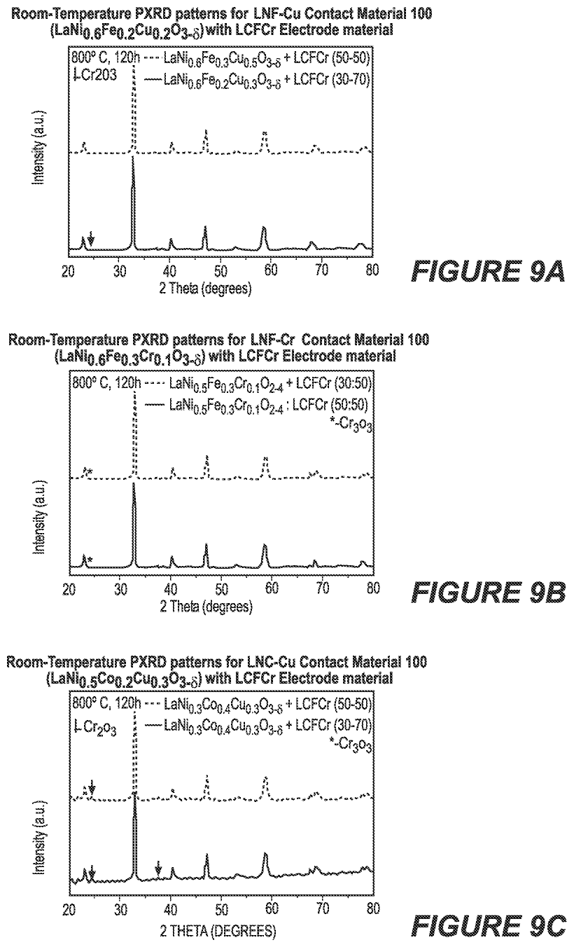

As shown in FIGS. 9A-9C, the heat-treated mixtures—of the contact material 100 and the LCFCr electrode material—retained the original rhombohedral crystal structure. When compared to the PXRD pattern of the individual materials (e.g., the contact material 100 and the LCFCr electrode material), no additional XRD peaks were detected, thereby indicating chemical compatibility between the electrode material and the contact materials 100.

Reactivity between the interconnect material (i.e., Crofer 22 APU) and the contact material 100 and/or electrode material was characterized by: screen painting the contact material 100 over the pre-oxidized interconnect material; heating the screen-painted interconnect material at 800° C. for 120 hours in air; and characterizing presence of secondary phases, after heat treatment, via XRD.

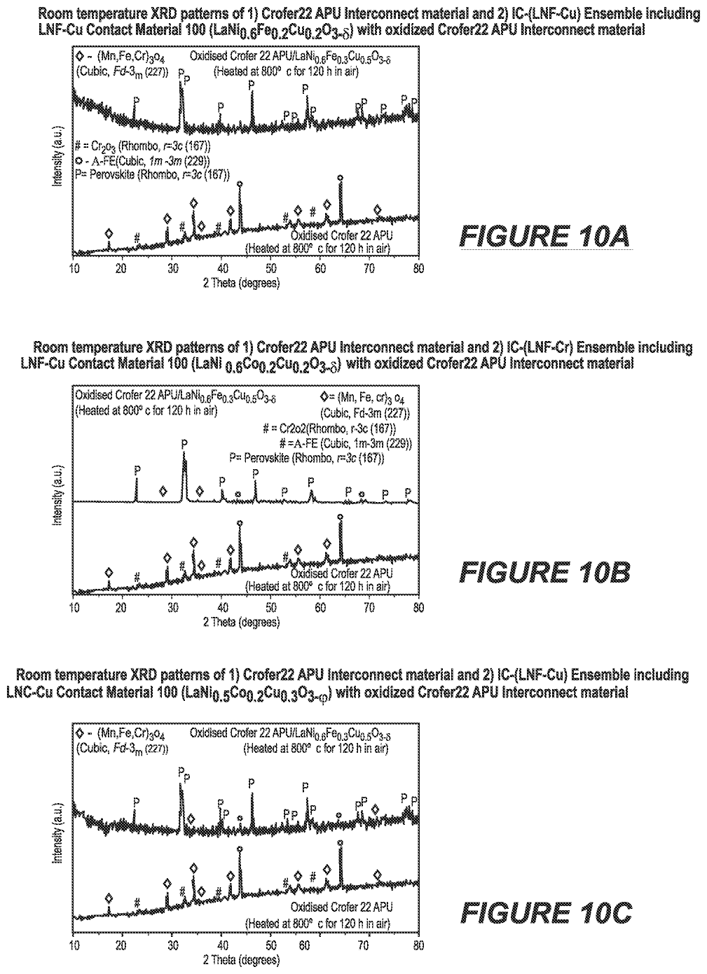

As shown in FIGS. 10A-10C, presence of secondary phases was not observed when compared to the as-prepared phases of the contact materials 100 and the interconnect material, thereby indicating chemical compatibility between the interconnect material and the contact materials 100.

### 5.8.4 Example 8: Area Specific Resistance

Area specific resistance (or “ASR”) between each of the contact materials 100 and the electrode material and/or the interconnect material was measured. In particular, for each contact material 100 of Example 8—including the LNF-Cu contact material 100 including LaNi_{0.6}Fe_{0.2}Cu_{0.2}O_{3-δ}, the LNF-Cr contact material 100 including LaNi_{0.6}Fe_{0.3}Cr_{0.1}O_{3-δ}, and the LNC-Cu contact material 100 including LaNi_{0.5}Co_{0.2}Cu_{0.3}O₃—a first assembly (or “IC-(CM)” assembly) including the interconnect material and the contact material 100 was generated. Further, for each contact material 100 of Example 8, a second assembly (or “IC-(CM)-LCFCr” assembly) including the interconnect material, the contact material 100, and the electrode material was generated.

To generate the IC-(CM) assembly, a slurry containing powder of the contact material 100 was screen painted over the pre-oxidized interconnect formed of the interconnect material.

To generate the IC-(CM)-LCFCr assembly, both a co-fired sample (or “CF” sample) and a separately-sintered sample (or “SS” sample) were prepared. In particular, for SS samples, the IC-(CM) assembly was sintered at 1000° C. for 5 hours, after which the electrode material was screen painted over the contact material 100 to form the IC-(CM)-LCFCr assembly. The IC-(CM)-LCFCr assembly was then sintered for an additional 5 hours at 1000° C. Alternatively, CF samples were prepared by screen painting the contact material 100 over the interconnect material, followed by depositing of the electrode material over the contact material 100 (e.g., the contact layer 102) to form the IC-(CM)-LCFCr assembly. The IC-(CM)-LCFCr assembly was then sintered at 1000° C. for 5 hours.

Each assembly was connected to an external measuring circuit. In particular, each IC-(CM) assembly included: a first layer of Pt paste applied to a surface of the interconnect—opposite a contact layer formed of the contact material 100; a first Pt mesh layer including two Pt wires applied to the first Pt layer opposite the interconnect; a second layer of Pt paste applied to a surface of the contact layer 102—opposite the interconnect; a second Pt mesh layer including two Pt wires and applied to the second Pt layer opposite the contact layer 102. Each IC-(CM)-LCFCr assembly included: a first layer of Pt paste applied to a surface of the interconnect—opposite a contact layer formed of the contact material 100; a first Pt mesh layer including two Pt wires applied to the first Pt layer opposite the interconnect; a second layer of Pt paste applied to a surface of the electrode material—opposite the contact layer 102; and a second Pt mesh layer including two Pt wires and applied to the second Pt layer opposite the electrode material. Each ensemble—including layers of Pt paste and Pt mesh—were sintered at 850° C. for 2 hours.

ASR measurements were collected at 800° C. by chronopotentiometry, applying 300 mA of current via an IVIUM potentiostats. The results are summarized in Table 6 below.

TABLE 6

| Ensemble | ASR (Ω cm²) |
|---|---|
| IC-(LNF-Cu) | 0.094 ± 0.0062 |
| IC-(LNF-Cr) | 0.023 ± 4.58 · 10⁻⁴ |
| IC-(LNC-Cu) | 0.032 ± 1.68 · 10⁻⁴ |
| IC-(LNF-Cr)-LCFCr (SS) | 0.049 ± 3.47 · 10⁻⁴ |
| IC-(LNC-Cu)-LCFCr (SS) | 0.083 ± 0.0085 |
| IC-(LNF-Cr)-LCFCr (CF) | 0.028 ± 8.44 · 10⁻⁵ |
| IC-(LNC-Cu)-LCFCr (CF) | 0.037 ± 6.98 · 10⁻⁵ |

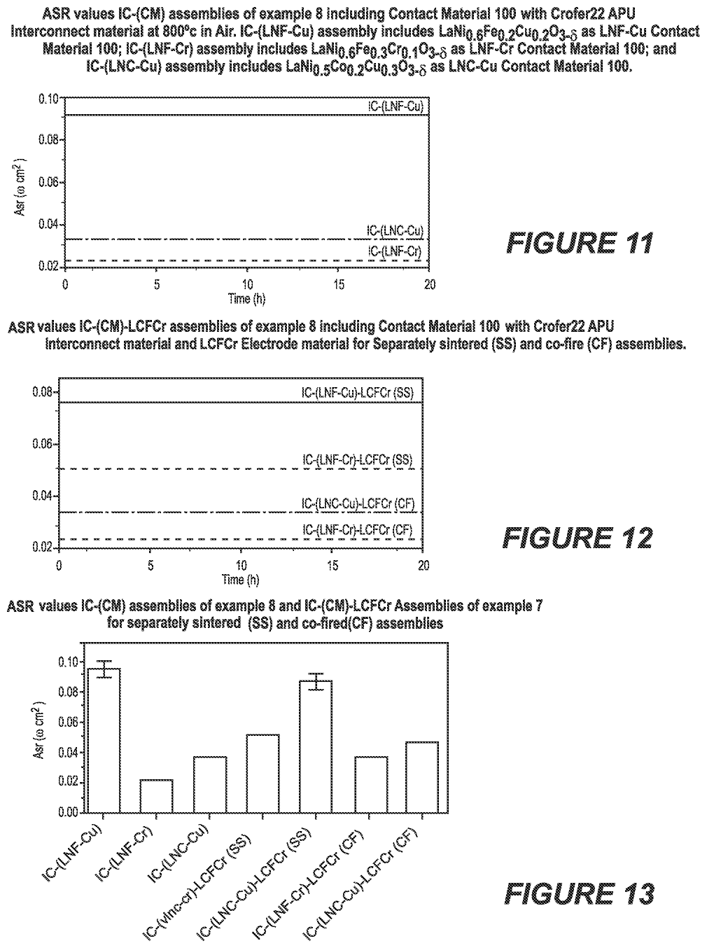

As shown in FIGS. 11-13, the LNF-Cu contact material 100 exhibited the highest ASR value while the LNF-Cr contact material 100 exhibited the lowest ASR value. Further, the CF samples exhibited lower ASR values than the SS samples.

### 6. Variation: RSOFC Electrode

In one variation, the contact material too can be configured to form an electrode in a reversible solid-oxide fuel cell. In particular, in this variation, the contact material 100 can be configured to form an oxygen electrode and/or a fuel electrode, thereby reducing a quantity and/or size of layers within a resulting stack 104 (e.g., a reversible fuel cell stack).

In one implementation, as shown in FIGS. 15D, 15E, and 15F, a stack 104 (e.g., a reversible fuel cell stack) can include a first reversible fuel cell unit including: a first oxygen electrode formed of the contact material 100 and arranged across a first surface of a first electrolyte; and a first fuel electrode formed of the contact material 100 and arranged across a second surface of the electrolyte opposite the first surface. The stack 104 can further include: a second reversible fuel cell unit including: a second oxygen electrode formed of the contact material 100 and arranged across a third surface of a second electrolyte; and a second fuel electrode formed of the contact material 100 and arranged across a fourth surface of the second electrolyte opposite the third surface. The stack 104 can further include an interconnect arranged between the first oxygen electrode of the first reversible fuel cell unit and the second fuel electrode of the second reversible fuel cell unit. In this example, by forming the oxygen and fuel electrodes with the contact material 100, the interconnect can exhibit compatibility with both the oxygen and fuel electrodes, thereby enabling exclusion of additional contact layers 102 from the stack 104. The stack 104 can therefore include fewer layers, thus reducing the manufacturing complexity of the stack 104 and a quantity of materials incorporated within the stack 104.

For example, the contact material 100 can include La_{0.3}Ca_{0.6}Ce_{0.1}Fe_{0.6}Ni_{0.1}Cr_{0.3}O_{3-δ}. In this example, the oxygen electrode and the fuel electrode can be formed of the contact material 100. The contact material 100 can be configured to exhibit a target thermal expansion coefficient within a threshold deviation (e.g., within 5.0×10⁻⁶K⁻¹) of a thermal expansion coefficient of the interconnect. Further, the contact material 100 can be configured to exhibit a target reactivity (e.g., no reactivity)—such as exhibited by absence of secondary structures in the crystal structure (e.g., a rhombohedral crystal structure) of the contact material 100—when mixed with and/or contacting (e.g., sintered with) the interconnect material. The electrodes—formed of the contact material 100—can therefore be directly applied to surfaces of the electrolyte. Alternatively, in another example, the electrode material—forming the oxygen electrode and/or fuel electrode—can be distinct from the contact material 100. In this example, the contact material 100 can similarly include La_{0.3}Ca_{0.6}Ce_{0.1}Fe_{0.6}Ni_{0.1}Cr_{0.3}O_{3-δ}. However, the contact material 100 can be applied directly to the interconnect to form a contact layer 102 arranged between the interconnect and the oxygen electrode and/or fuel electrode.

As a person skilled in the art will recognize from the previous detailed description and from the figures and claims, modifications and changes can be made to the embodiments of the invention without departing from the scope of this invention as defined in the following claims.

I claim:

1. A contact material:
comprising:
a base material comprising a first amount of Lanthanum, a second amount of Nickel, and a third amount of Oxygen;
a fourth amount of a first doping agent configured to stabilize a crystal structure of the base material; and
a fifth amount of a second doping agent, in the set of doping agents, configured to reduce a thermal expansion coefficient of the base material; and
exhibiting:
a thermal expansion coefficient between 10.0×10⁻⁶K⁻¹ and 15.0×10⁻⁶K⁻¹ at temperatures between 25 degrees Celsius and 1100 degrees Celsius; and
an electrical conductivity greater than 200 Siemens-per-centimeter at temperatures within a temperature range of 700 degrees Celsius to 1300 degrees Celsius.

2. The contact material of claim 1, configured to form a set of contact layers in a reversible solid-oxide fuel cell stack, comprising:
a first fuel cell comprising:
a first electrolyte;
a first oxygen electrode, in a set of oxygen electrodes, arranged across a first surface of the first electrolyte; and
a first fuel electrode, in a set of fuel electrodes, arranged across a second surface, opposite the first surface, of the first electrolyte;
a second fuel cell comprising:
a second electrolyte;
a second oxygen electrode, in the set of oxygen electrodes, arranged across a third surface of the second electrolyte; and
a second fuel electrode, in the set of fuel electrodes, arranged across a fourth surface, opposite the third surface, of the second electrolyte;
an interconnect arranged between the second surface of the first fuel cell and the third surface of the second fuel cell;
a first contact layer in the set of contact layers:
arranged between the interconnect and the second surface of the first fuel cell unit; and
configured to electrically couple the interconnect to the first fuel electrode; and
a second contact layer in the set of contact layers:
arranged between the interconnect and the third surface of the second fuel cell unit; and
configured to electrically couple the interconnect to the second oxygen electrode.

3. The contact material of claim 1, configured to form a contact layer:
arranged between an interconnect and an electrode in a fuel cell; and
configured to:
transfer electrical energy between the interconnect and the electrode;
exhibit sintering activity corresponding to sintering activity of the interconnect and the electrode;
exhibit less than a threshold reactivity with the interconnect and the electrode; and
exhibit thermal expansion properties corresponding to thermal expansion properties of the interconnect and the electrode.

4. The contact material of claim 3:
wherein the electrode is formed of an electrode material including La_{0.3}Ca_{0.7}Fe_{0.7}Cr_{0.3}O_{3-δ};
wherein the interconnect is formed of an interconnect material comprising Crofer 22 APU ferritic stainless steel; and
wherein the contact layer is configured to exhibit the thermal expansion coefficient:
within a first threshold deviation of a second thermal expansion coefficient of the electrode material at a target temperature between 25 degrees Celsius and 1100 degrees Celsius; and
within a second threshold deviation of a third thermal expansion coefficient of the interconnect material at the target temperature between 25 degrees Celsius and 1100 degrees Celsius.

5. The contact material of claim 1:
wherein the fourth amount of the second doping agent comprises the fourth amount of the second doping agent comprising Iron; and
wherein the fifth amount of the fifth doping agent comprises the fifth amount of the fifth doping agent comprising Copper.

6. The contact material of claim 5:
exhibiting an electrical conductivity value exceeding 240 Siemens-per-centimeter at 800 degrees Celsius;
exhibiting absence of secondary crystal structures when mixed with an electrode material and held at 800 degrees Celsius over a 120-hour test period; and
exhibiting absence of secondary crystal structures when mixed with an interconnect material and held at 800 degrees Celsius over a 120-hour test period.

7. The contact material of claim 5:
wherein the first amount of Lanthanum, the second amount of Nickel, and the third amount of Oxygen cooperate to form a perovskite material;
wherein the second amount of Nickel and the first amount of Lanthanum define a first stoichiometric ratio of the second amount of Nickel to the first amount of Lanthanum of 0.6;
wherein the fourth amount of Iron and the first amount of Lanthanum define a second stoichiometric ratio of the fourth amount of Iron to the first amount of Lanthanum of 0.2; and
wherein the fifth amount of Copper and the first amount of Lanthanum define a third stoichiometric ratio of the fifth amount of Copper to the first amount of Lanthanum of 0.2.

8. The contact material of claim 1:
wherein the fourth amount of the second doping agent comprises the fourth amount of the second doping agent comprising Iron; and
wherein the fifth amount of the fifth doping agent comprises the fifth amount of the fifth doping agent comprising Chromium.

9. The contact material of claim 8:
exhibiting an electrical conductivity value exceeding 270 Siemens-per-centimeter at 800 degrees Celsius;
exhibiting absence of secondary crystal structures when mixed with an electrode material and held at 800 degrees Celsius over a 120-hour test period; and
exhibiting absence of secondary crystal structures when mixed with an interconnect material and held at 800 degrees Celsius over a 120-hour test period.

10. The contact material of claim 8:
wherein the first amount of Lanthanum, the second amount of Nickel, and the third amount of Oxygen cooperate to form a perovskite material;
wherein the second amount of Nickel and the first amount of Lanthanum define a first stoichiometric ratio of the second amount of Nickel to the first amount of Lanthanum of 0.6;
wherein the fourth amount of Iron and the first amount of Lanthanum define a second stoichiometric ratio of the fourth amount of Iron to the first amount of Lanthanum of 0.3; and
wherein the fifth amount of Chromium and the first amount of Lanthanum define a third stoichiometric ratio of the fifth amount of Chromium to the first amount of Lanthanum of 0.1.

11. The contact material of claim 1:
wherein the fourth amount of the first doping agent comprises the fourth amount of the first doping agent comprising Cobalt; and
wherein the fifth amount of the fifth doping agent comprises the fifth amount of the fifth doping agent comprising Copper.

12. The contact material of claim 11:
wherein the first amount of Lanthanum, the second amount of Nickel, and the third amount of Oxygen cooperate to form a perovskite material;
wherein the second amount of Nickel and the first amount of Lanthanum define a first stoichiometric ratio of the second amount of Nickel to the first amount of Lanthanum of 0.5;
wherein the fourth amount of Cobalt and the first amount of Lanthanum define a second stoichiometric ratio of the fourth amount of Cobalt to the first amount of Lanthanum of 0.2; and
wherein the fifth amount of Copper and the first amount of Lanthanum define a third stoichiometric ratio of the fifth amount of Copper to the first amount of Lanthanum of 0.3.

13. The contact material of claim 1:
wherein the fourth amount of the first doping agent comprises the fourth amount of the first doping agent comprising Cobalt;
wherein the fifth amount of the fifth doping agent comprises the fifth amount of the fifth doping agent comprising Iron.

14. The contact material of claim 1:
wherein the fourth amount of the first doping agent is configured to stabilize the crystal structure comprising a rhombohedral crystal structure;
wherein the rhombohedral crystal structure exhibits no change when mixed with an electrode material and held at 800 degrees Celsius over a 120-hour test period; and
wherein the rhombohedral crystal structure exhibits no change when mixed with an interconnect material and held at 800 degrees Celsius over a 120-hour test period.

15. A contact material:
comprising:
a base material comprising:
a first amount of Lanthanum;
a second amount of Nickel; and
a fourth amount of Oxygen;
a third amount of Iron configured to stabilize the base material; and
a fifth amount of a doping agent configured to limit thermal expansion of the base material; and
exhibiting:
a thermal expansion coefficient between 10.0×10⁻⁶K⁻¹ and 15.0×10⁻⁶K⁻¹ at temperatures between 25 degrees Celsius and 1100 degrees Celsius; and
an electrical conductivity value greater than 200 Siemens-per-centimeter at temperatures within a temperature range of 700 degrees Celsius to 1300 degrees Celsius.

16. The contact material of claim 15:
wherein the fifth amount of the doping agent comprises the fifth amount of the doping agent comprising Copper;
wherein the second amount of Nickel and the first amount of Lanthanum define a first stoichiometric ratio of the second amount of Nickel to the first amount of Lanthanum of 0.6;
wherein the third amount of Iron and the first amount of Lanthanum define a second stoichiometric ratio of the third amount of Iron to the first amount of Lanthanum of 0.2;
wherein the fourth amount of Oxygen and the first amount of Lanthanum define a third stoichiometric ratio of the fourth amount of Oxygen to the first amount of Lanthanum of 3.0;
wherein the fifth amount of Copper and the first amount of Lanthanum define a fourth stoichiometric ratio of the fifth amount of Copper to the first amount of Lanthanum of 0.2; and
wherein the electrical conductivity value exceeds 240 Siemens-per-centimeter at 800 degrees Celsius.

17. The contact material of claim 15:
wherein the fifth amount of the doping agent comprises the fifth amount of the doping agent comprising Chromium;
wherein the second amount of Nickel and the first amount of Lanthanum define a first stoichiometric ratio of the second amount of Nickel to the first amount of Lanthanum of 0.6;
wherein the third amount of Iron and the first amount of Lanthanum define a second stoichiometric ratio of the third amount of Iron to the first amount of Lanthanum of 0.3;
wherein the fourth amount of Oxygen and the first amount of Lanthanum define a third stoichiometric ratio of the fourth amount of Oxygen to the first amount of Lanthanum of 3.0;
wherein the fifth amount of Chromium and the first amount of Lanthanum define a third stoichiometric ratio of the fifth amount of Chromium to the first amount of Lanthanum of 0.1; and
wherein the electrical conductivity value exceeds 270 Siemens-per-centimeter at 800 degrees Celsius.

18. A contact material:
comprising:
a base material comprising:
a first amount of Lanthanum;
a second amount of Nickel; and
a fourth amount of Oxygen;
a third amount of Cobalt configured to stabilize the base material; and
a fifth amount of a doping agent configured to limit thermal expansion of the base material; and
exhibiting:
electrical conductivity values greater than 300 Siemens-per-centimeter at temperatures within a temperature range of 700 degrees Celsius to 1300 degrees Celsius; and
a target thermal expansion coefficient within a threshold deviation of:
a first thermal expansion coefficient of an electrode material; and
a second thermal expansion coefficient of an interconnect material.

19. The contact material of claim 18:
wherein the fifth amount of the doping agent comprises the fifth amount of the doping agent comprising Iron;
wherein the second amount of Nickel and the first amount of Lanthanum define a first stoichiometric ratio of the second amount of Nickel to the first amount of Lanthanum of 0.6;
wherein the third amount of Cobalt and the first amount of Lanthanum define a second stoichiometric ratio of the third amount of Cobalt to the first amount of Lanthanum of 0.2;
wherein the fourth amount of Oxygen and the first amount of Lanthanum define a third stoichiometric ratio of the fourth amount of Oxygen to the first amount of Lanthanum of 3.0;
wherein the fifth amount of Iron and the first amount of Lanthanum define a third stoichiometric ratio of the fifth amount of Iron to the first amount of Lanthanum of 0.2;
wherein the contact material exhibits an electrical conductivity value exceeding 380 Siemens-per-centimeter at 800 degrees Celsius; and
wherein the contact material exhibits a thermal expansion coefficient value between 10.0×10⁻⁶K⁻¹ and 15.0×10⁻⁶K⁻¹ at temperatures between 25 degrees Celsius and 1100 degrees Celsius.

20. The contact material of claim 18:
wherein the fifth amount of the doping agent comprises the fifth amount of the doping agent comprising Iron;
wherein the second amount of Nickel and the first amount of Lanthanum define a first stoichiometric ratio of the second amount of Nickel to the first amount of Lanthanum of 0.6;
wherein the third amount of Cobalt and the first amount of Lanthanum define a second stoichiometric ratio of the third amount of Cobalt to the first amount of Lanthanum of 0.3;
wherein the fourth amount of Oxygen and the first amount of Lanthanum define a third stoichiometric ratio of the fourth amount of Oxygen to the first amount of Lanthanum of 3.0;
wherein the fifth amount of Iron and the first amount of Lanthanum define a third stoichiometric ratio of the fifth amount of Iron to the first amount of Lanthanum of 0.1;
wherein the contact material exhibits an electrical conductivity value exceeding 600 Siemens-per-centimeter at 800 degrees Celsius; and
wherein the contact material exhibits a thermal expansion coefficient value between 10.0×10⁻⁶K⁻¹ and 15.0×10⁻⁶K⁻¹ at temperatures between 25 degrees Celsius and 1100 degrees Celsius.
